(19) United States
(12) Patent Application Publication
(10) Pub. No.: US 2017/0139933 A1
(43) Pub. Date: May 18, 2017

(54) Electronic Device, And Computer-Readable Storage Medium For Quickly Searching Video Segments

(71) Applicants: Le Holdings (Beijing) Co., Ltd., Beijing (CN); Le Shi Zhi Xin Electronic Technology (Tianjin) Limited, Tianjin (CN)

(72) Inventor: Xing Yang, Tianjin (CN)

(73) Assignees: Le Holdings (Beijing) Co., Ltd., Beijing (CN); Le Shi Zhi Xin Electronic Technology (Tianjin) Limited, Tianjin (CN)

(21) Appl. No.: 15/241,449

(22) Filed: Aug. 19, 2016

Related U.S. Application Data
(63) Continuation of application No. PCT/CN2016/088569, filed on Jul. 5, 2016.

(30) Foreign Application Priority Data
Nov. 18, 2015 (CN) 201510799082.5

(51) Int. Cl. G06F 17/30; H04N 21/8549; G06K 9/00; H04N 21/845; G11B 27/19; G11B 27/031

(52) U.S. Cl. CPC G06F 17/3082; G11B 27/19; G11B 27/031; G06K 9/00751; H04N 21/8455; H04N 21/8549; G06K 9/00281; G06F 17/30846

(57) ABSTRACT

Disclosed are a method, an electronic device, and a computer-readable medium for quickly searching video segments. The method includes: analyzing each frame at a server, setting a frame as a starting frame, and recording a time point when the starting frame appears; when the video feature appears in each frame following the staring frame, accumulating the number of the video feature until the video feature does not appear in an ending frame, and then forming a video segment; and when the video feature is selected at a client, acquiring, a list of the video feature appears from the server, and automatically searching a time point when the video feature appears in the video. Compared with a searching method regarding a fixed time point in the prior art, searching a video segment with respect to a specified video feature employed in the present disclosure is more convenient and quicker.

### CROSS REFERENCE TO RELATED APPLICATIONS

This application is a continuation of International Application No. PCT/CN2016/088569, filed on Jul. 5, 2016, which is based upon and claims priority to Chinese Patent Application No. 201510799082.5, filed on Nov. 18, 2015, the entire contents of which are incorporated herein by reference.

### TECHNICAL FIELD

The present disclosure relates to a method, an electronic device, a system and a computer-readable medium for quickly searching video segments, and, and more particularly, the method and the system search interested video segments based on recognition of a specified video feature (for example, a human face).

### BACKGROUND

A user tends to be not interested in an entire video when the user is watching the video on a display screen. Due to the user's personal preference and time limitation, the user often desires to skip to a special video segment for viewing this video segment.

For example, when the user is watching a movie on a display screen, the user likely only pays attention to a certain film star existing in the movie; therefore, the user only desires to view scenes where the film star appears. This requires that a method for searching video segments can be provided, such that the user can search interested video segments quickly and conveniently. In this case, a method for searching at a fixed time point is often used in the prior art. For example, in a movie video with a duration of 60 minutes, a 20 min point and a 40 min point are selected as fixed time points. The movie video jumps directly to the time point of 20th minute and starts playing from this time point if the user selects the 20 min point. And the movie video jumps directly to the time point of 40th minute and starts playing from this time point if the user selects the 40 min point.

It is found by the inventor during the process of implementing the present disclosure that: this method for searching video segments at a fixed time point is extremely inaccurate. When a video segment is searched and played at a fixed time point, some scenes which the user desires to view are often omitted, and the user often has to view some segments which the user does not desire to view. If the user desires to view a segment relating to a certain person or scene, this requirement cannot be met through this method for searching a video segment at a fixed time point.

### SUMMARY

The present disclosure relate to a method, an electronic device, and a computer-readable medium for quickly searching a video segments, which aim to search an interested video segment more quickly and conveniently based on recognition of a specified video feature (for example, a human face).

According to a first aspect, the present disclosure provides a method for quickly searching video segments by an electronic device, including: analyzing each frame in a video, setting a frame as a starting frame once a first video feature appears in the frame analyzed, and recording a time point when the starting frame appears in the video; and when the first video feature appears in each frame following the staring frame, accumulating the number of the first video feature until the first video feature does not appear in an ending frame, and forming a video fragment with respect to the first video feature between the starting frame and the ending frame, such that the time point when the first video feature appears in the video can be searched.

According to a second aspect, the present disclosure further provides an electronic device for quickly searching video segments, including: at least one processor; and a memory communicably connected with the at least one processor for storing instructions executable by the at least one processor, wherein execution of the instructions by the at least one processor causes the at least one processor to: analyze each frame in a video one by one, set a frame as a starting frame once a specified first video feature appears in the frame, and record a time point when the starting frame appears in the video; and when the first video feature appears in each frame following the staring frame, accumulate the number of the first video feature until the first video feature does not appear in an ending frame, and form a video segment with respect to the first video feature between the starting frame and the ending frame, such that the time point when the first video feature appears in the video can be searched.

According to a third aspect of the present disclosure, the present disclosure further provides non-transitory computer-readable storage medium storing executable instructions that, when executed by an electronic device with a touch-sensitive display, cause the electronic device to: analyze each frame in a video, set a frame as a starting frame once a first video feature appears in the frame analyzed, and record a time point when the starting frame appears in the video; and when the first video feature appears in each frame following the staring frame, accumulate the number of the first video feature until the first video feature does not appear in an ending frame, and form a video fragment with respect to the first video feature between the starting frame and the ending frame, such that the time point when the first video feature appears in the video can be searched.

According to the method and the electronic device for quickly searching video segments of the present disclosure, the video segment with respect to the specific video feature (for example, a character) is processed through the server, then the video segment is searched at the client. In this way, a user can conveniently search and observe a desired video segment with respect to the specific video feature through the effective cooperation between the server and the client. Compared with the method for searching video segments at fixed time points in the prior art, searching a video segment with respect to a specified video feature employed in the present disclosure is much more convenient and quicker.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows a flow chart of a processing procedure at a server in accordance with some embodiments.

FIG. 2 shows a flow chart of a method for searching at a client in accordance with some embodiments;

FIG. 3 shows a structure block diagram of a searching device in accordance with some embodiments;

FIG. 4 shows a structure block diagram of a searching device in accordance with some embodiments;

FIG. 5 shows a structure block diagram of a searching device in accordance with some embodiments;

FIG. 6 shows a structure block diagram of a system for quickly searching video segments in accordance with some embodiments;

FIG. 7 shows a structure block diagram of a system for quickly searching video segments in accordance with some embodiments;

FIG. 8 shows a structure block diagram of a system for quickly searching video segments in accordance with some embodiments; and

FIG. 9 shows a system structure diagram of an electronic device for quickly searching video segments in accordance with some embodiments.

### DETAILED DESCRIPTION

The embodiments of the present disclosure, which are different from a method for searching at a fixed time point in the prior art, conduct respective search operations through a specific video feature appointed by a user, such that the user is enabled to quickly search a video segment which he/she desires to view. Specially, the user provides a picture, and a specific video feature (for example, a character frame, a scenario frame, or the like) in the picture provided by the user is searched in the video in advance, and automatic searching with respect to the specific video feature is conducted, such that the user can conveniently find a specific frame in the video where the specific video feature locates, thus determining a specific position of the video feature in the entire video.

The foregoing process needs an effective cooperation between a server and a client. How to conduct the cooperation between the server and the client to implement the substantial concept of the present disclosure above will be introduced hereinafter with reference to the embodiments. It should be noted that the “specific video feature” is embodied as “character” hereinafter. But it is to be understood that the present disclosure is not limited to the search of characters, and search of other video features shall also fall within the protection scope of the present disclosure.

Hereinafter, a first embodiment will be introduced.

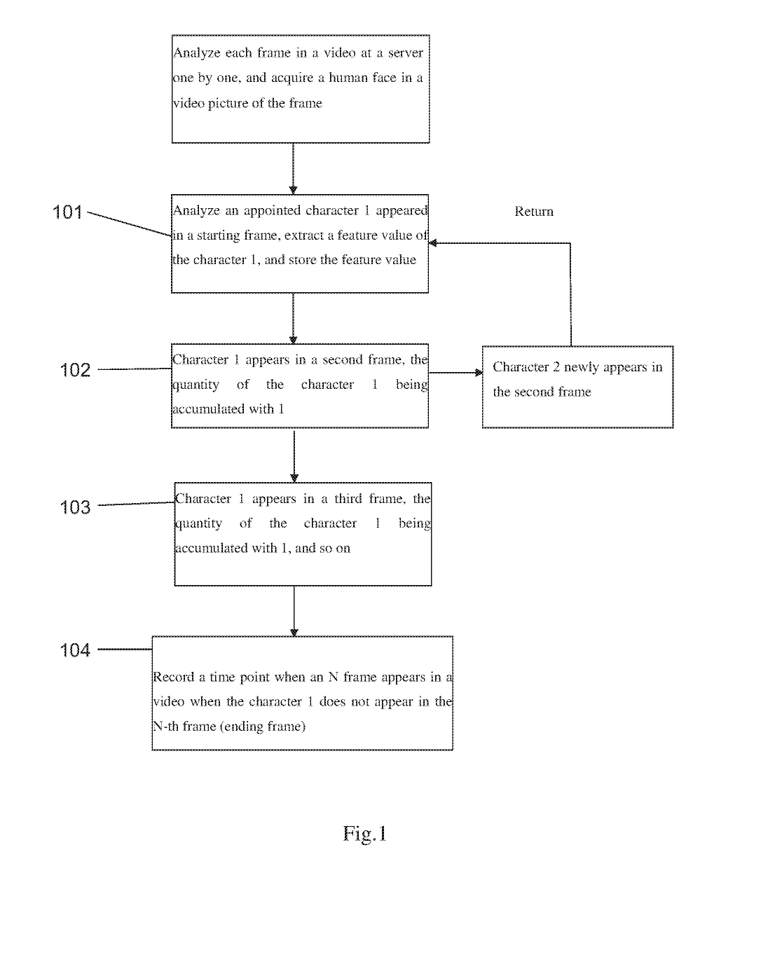

FIG. 1 shows a processing procedure at a server of a method for conducting searching operations according to one embodiment of the present disclosure.

In step 100, a server analyzes each frame in a video so as to acquire a specific face image in a video picture of the frame.

Then, in step 101, when a character 1 appointed by a user appears in the video picture of the frame analyzed, the frame is set as a starting frame, and a feature value of the character 1 is extracted according to an algorithms library, then the feature value of the character 1 is stored in a remote server, and a time point when a first frame appears in the video is recorded in the meanwhile.

For instance, physical features (for example, a nose feature, an eye feature, a mouth feature and an ear feature) of characters (for example, the character 1, a character 2, a character 3 and a character 4) representing different video features may be recorded in the algorithms library in advance:

| | | | | |
|---|---|---|---|---|
| Character 1 | Nose feature | Eye feature | Mouth feature | Ear feature |
| Character 2 | Nose feature | Eye feature | Mouth feature | Ear feature |
| Character 3 | Nose feature | Eye feature | Mouth feature | Ear feature |
| Character 4 | Nose feature | Eye feature | Mouth feature | Ear feature |

When video pictures of the frame are analyzed, pairing comparison is performed between the character 1 in the video picture and a feature value pre-recorded in the algorithms library. In a case that the character 1 presented in the video picture is determined to match each recorded feature value (for example, nose, eye, mouth and ear features) related to the character 1 which is recorded in the algorithms library, the various feature values of the character 1 will be remotely transmitted to a remote server and stored in the remote server; and a time point when a matched frame appears in the video under the pairing comparison will also be recorded in the meanwhile.

In step 102, a second frame next following the first frame is analyzed.

When the character 1 continually appears in the second frame and the character 2 starts appearing in the second frame, the number of the character 1 is accumulated with 1 since the character 1 has appeared in the first frame according to the recognition of the algorithms library. The operation of step 101 is performed with respect to the character 2.

To be specific, various feature values of the character 2 are also pre-recorded in the algorithms library; therefore, pairing comparison is also performed between the character 2 presented in the video picture and each feature value related to the character 2 which is recorded in the algorithms library according to the method as described above. In a case that the pairing comparison represents a result of “match”, the various feature values of the character 2 will also be stored in the remote server, and a time point when the second frame (as a starting frame of the character 2) appears in the video is recorded.

In step 103, a third frame next following the second frame is analyzed.

When the character 1 continually appears in the third frame, the number of the character 1 is accumulated with 1 since it has been determined that the character 1 has appeared in the first frame and the second frame according to the recognition of the algorithms library, and so on.

In step 104, until the character 1 does not appear in an N-th frame, then a time point of the N-th frame in the video at this moment is recorded, wherein the N-th frame is called as an ending frame with respect to the character 1. A video segment with respect to the character 1 is formed between the starting frame and the ending frame.

Similarly, according to the foregoing method, a starting frame and an ending frame with respect to other characters (for example, the character 2, the character 3 and the character 4) are also investigated in the meanwhile, thus determining respective video segments with respect to other characters.

One processing of the server is completed through the foregoing procedure.

It should be noted that if the server only conducts the processing with respect to one character, then the foregoing procedure will become simpler, which needs only to investigate the number of the character 1 appeared in the video and the ending frame thereof, and the character 2 and/or other characters are not needed to be investigated.

Moreover, it should also be noted that after the N-th frame, the foregoing steps may also be repeated with respect to the character 1, and the step 101 and following steps may be restarted. Under this circumstance, the character 1 will appear at next starting frame again, and will be ended at next ending frame again. In this way, a next video segment with respect to the character 1 is formed between the next starting frame and the next ending frame.

The embodiment is employed to complete selection of the video segment with respect to a plurality of specific video features by using the server to conduct the processing. The user can conveniently search and observe a desired video segment with respect to the specific video feature through the effective cooperation between the server and the client. Compared with the searching method regarding a fixed time point in the prior art, the method employed in the present disclosure is not only more convenient and quicker, but also can search and select a plurality of video features. Moreover, after extracting the feature value of the specific video feature, the feature value is stored in the remote server, and may be used in next comparison, such that the searching efficiency and accuracy are greatly improved.

Hereinafter, a second embodiment will be introduced.

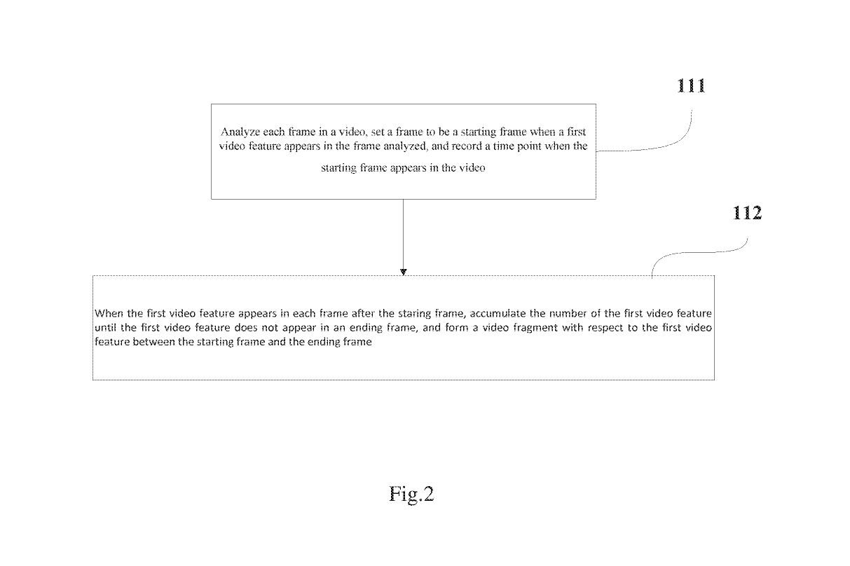

FIG. 2 shows a processing procedure at a server of a searching method according to another embodiment of the present disclosure.

In step 111, each frame in a video is analyzed, a frame is set as a starting frame when a first video feature appears in the frame analyzed, and a time point when the starting frame appears in the video is recorded.

To be specific, when a character 1 appointed by a user appears in the video picture of the frame analyzed, the frame is set as a starting frame, and a feature value of the character 1 is extracted according to an algorithms library, then the feature value of the character 1 is stored in a remote server, and a time point when a first frame appears in the video is recorded in the meanwhile.

In step 112, when the first video feature appears in each frame following the staring frame in the video, the number of the first video feature is accumulated until the first video feature does not appear in an N-th frame, and a time point when the N-th frame in the video at this moment is recorded, wherein the N frame may be called as an ending frame with respect to the character 1. A video segment with respect to the character 1 is formed between the starting frame and the ending frame, such that a time point when the first video feature appears in the video can be searched.

The embodiment is employed to complete selection of the video segment with respect to the specific video feature by using the server to conduct a processing operation, and then the video segment is searched at the client. The user can conveniently search and observe a desired video segment with respect to the specific video feature through the effective cooperation between the server and the client. Compared with the searching method regarding a fixed time point in the prior art, searching a video segment with respect to a specified video feature employed in the present disclosure is much more convenient and quicker.

Corresponding operations of the client for the video already processed by the server will be introduced with reference to the embodiment hereinafter.

Hereinafter, a third embodiment will be introduced.

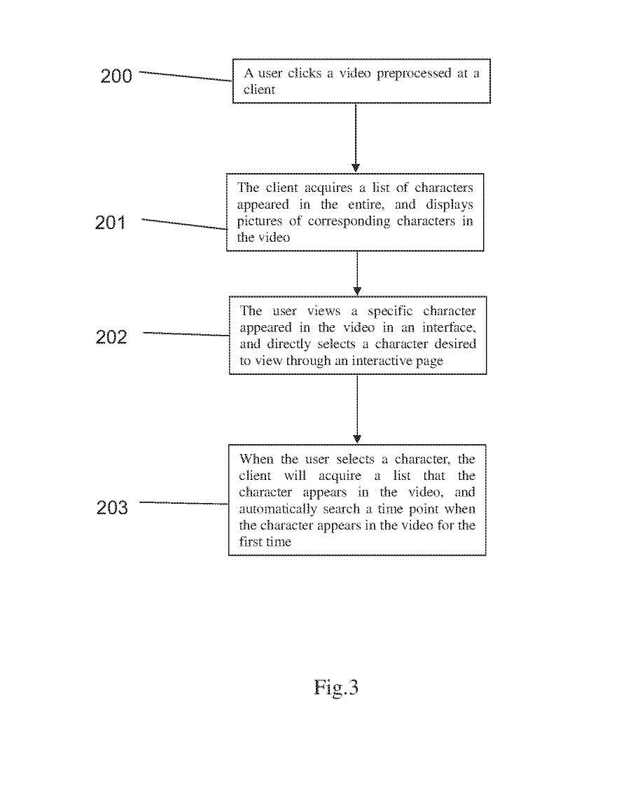

FIG. 3 shows a matching procedure of a method for searching at a client to a server according to one embodiment of the present disclosure.

To be specific, in step 200, a user may click the foregoing video processed at the client.

Then, in step 201, the client will acquire a list of characters appeared in the entire video from the server. Optionally, pictures of corresponding characters in the video may also be displayed at the client.

Then, in step 202, the user will see a specific character appeared in the video in an interface, and the user may directly select a character (for example, a specific actor) which he/she desires to view through an interactive page in the interface.

In step 203, when the user selects a certain character (for example, the character 1 as described above), the client will acquire all lists that the character appears in the video from the server, and automatically search a time point when the character appears in the video for the first time selected according to the lists.

Further, if the user desires to observe another video segment in the list with regard to the character, then the client will investigate a corresponding time point corresponding to a frame after the starting frame related to the character in the list until the video segment which he/she desires to view is finally searched. Under this case, the user will observe a character story which he/she desire to view.

For instance, a first video segment, a second video segment, a third video segment and a fourth video segment of the character 1, a character 2, a character 3 and a character 4 representing different video features are formed during the foregoing processing procedure.

Accordingly, the list will be formed as follows:

| | | | | |
|---|---|---|---|---|
| Character 1 | First video | Second video | Third video | Fourth video |
| | segment | segment | segment | segment |
| Character 2 | First video | Second video | Third video | Fourth video |
| | segment | segment | segment | segment |
| Character 3 | First video | Second video | Third video | Fourth video |
| | segment | segment | segment | segment |
| Character 4 | First video | Second video | Third video | Fourth video |
| | segment | segment | segment | segment |

The list may be intuitively presented in an interactive interface (for example, a TV screen) of the client. At this moment, the user may optionally click the respective first video segment, the second video segment, the third video segment and the fourth video segment of the character 1, the character 2, the character 3 and the character 4 in the interactive interface according to individual hobbies. For example, the user desires to view the second video segment of the character 3, then the user directly clicks “character 3/second video segment” in the screen, so that the user would see the respective video content which he/she desires to view.

Certainly, the list may be hidden to the user by the client. Under this case, if the user desires to view the second video segment of the character 3, then the user only needs to input: “character 3/second video segment” at the client, so that the user would see the video content which he/she desires to view.

It should be noted that the cooperation between the client and the server is introduced above by taking “character” for example. But it is to be understood that “character” only represents a specified video feature. In fact, searching with respect to other specified situations excluding the character may also be investigated during the cooperation process of the client and the server, for example, searching buildings, rivers, landscapes, or the like, appeared in the video.

The embodiment is employed to search video segments by the client, and the user is enabled to conveniently search and view a desired video segment with respect to the specific video feature through the effective cooperation between the server and the client. Compared with the searching method regarding a fixed time point in the prior art, searching a video segment with respect to a specified video feature employed in the present disclosure is much more convenient and quicker.

Hereinafter, a fourth embodiment will be introduced.

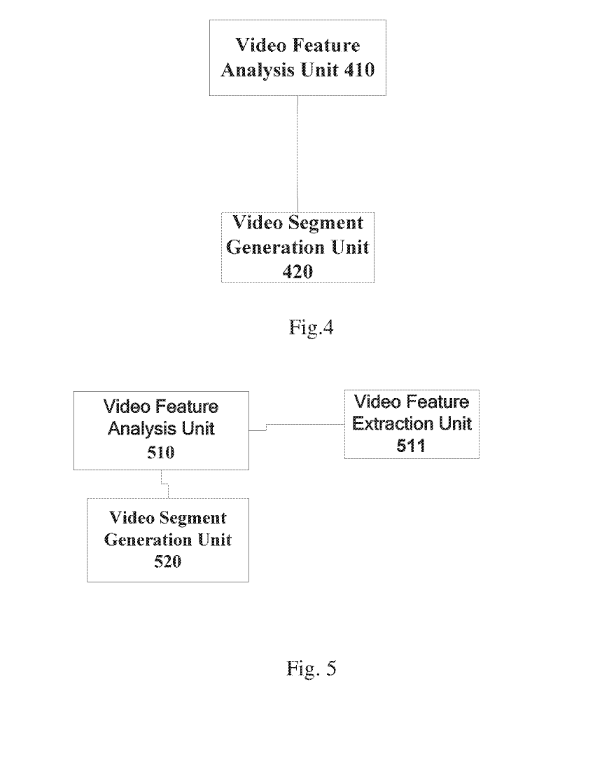

In the embodiment, a device for quick searching a video segment is provided. The device may be operated at a server, including a video feature analysis unit 410 and a video segment generation unit 420, as shown in FIG. 4.

The video feature analysis unit 410 is configured to analyze each frame in a video, set a frame as a starting frame when a first video feature appears in the frame analyzed, and record a time point when the starting frame appears in the video. When the video feature analysis unit 410 analyzes the video picture of the frame analyzed, pairing comparison is performed between a character 1 in the video picture and a feature value pre-recorded in an algorithms library. If the character 1 matches the feature value pre-recorded in an algorithms library, then it is deemed that the first video feature appears in the frame of picture.

The video segment generation unit 420 is configured to, when the first video feature appears in each frame following the staring frame, accumulate the number of the first video feature until the first video feature does not appear in an ending frame, and form a video segment with respect to the first video feature between the starting frame and the ending frame. To be specific, when the character 1 does not appear in an N-th frame, then a time point of the N-th frame in the video at this moment is recorded, wherein the N-th frame is called as an ending frame with respect to the character 1. The video segment generation unit 420 forms a video segment with respect to the character 1 between the starting frame and the ending frame. The video segment is used for enabling the client to search the time point when the first video feature appears in the video.

The embodiment is employed to complete selection of the video segment with respect to the specific video feature by using the server to process, and then the video segment is searched at the client. The user can conveniently search and observe the desired video segment with respect to the specific video feature through the effective cooperation between the server and the client. Compared with the searching method regarding a fixed time point in the prior art, searching a video segment with respect to a specified video feature employed in the present disclosure is much more convenient and quicker.

Hereinafter, a fifth embodiment will be introduced.

In the embodiment, a device for quick searching a video segment is provided. The device may be operated at a server, including a video feature analysis unit 510 and a video segment generation unit 520, as shown in FIG. 5.

The video feature analysis unit 510 is configured to analyze each frame in a video, set a frame as a starting frame when a first video feature appears in the frame analyzed, and record a time point when the starting frame appears in the video. When the video feature analysis unit 510 analyzes the video picture of the frame analyzed, pairing comparison is performed between a character 1 in the video picture and a feature value pre-recorded in an algorithms library. If the character 1 matches the feature value pre-recorded in an algorithms library, then it is deemed that the first video feature appears in the frame of picture.

The device further includes a feature value extraction unit 511, the feature value extraction unit being configured to extract a feature value with respect to the first video feature at the starting frame according to an algorithms library, and store the feature value. In a case that the character 1 presented in the video picture is determined to match each feature value (for example, nose, eye, mouth and ear features) related to the character 1 recorded in the algorithms library, the various feature values of the character 1 will be remotely transmitted to a remote server and stored in the remote server.

The video segment generation unit 520 is configured to, when the first video feature appears in each frame following the staring frame, accumulate the number of the first video feature until the first video feature does not appear in an ending frame, and form a video fragment with respect to the first video feature between the starting frame and the ending frame. To be specific, when the character 1 does not appear in an N-th frame, then a time point of the N-th frame in the video at this moment is recorded, wherein the N-th frame is called as an ending frame with respect to the character 1. The video segment generation unit 520 forms a video segment with respect to the character 1 between the starting frame and the ending frame. The video segment is used for enabling the client to search the time point when the first video feature appears in the video.

The embodiment is employed to complete selection of the video segment with respect to the specific video feature by using the server to conduct processing, and then the video segment is searched at the client. The user can conveniently search and observe the desired video segment with respect to the specific video feature through the effective cooperation between the server and the client. Moreover, because the feature value of the video feature is stored in the remote server, the feature value can be stored, such that other parties may acquire the feature value, and use the feature value to search a specified video feature. Compared with the searching method regarding a fixed time point in the prior art, searching a video segment with respect to a specified video feature employed in the present disclosure is much more convenient and quicker.

Hereinafter, a sixth embodiment will be introduced.

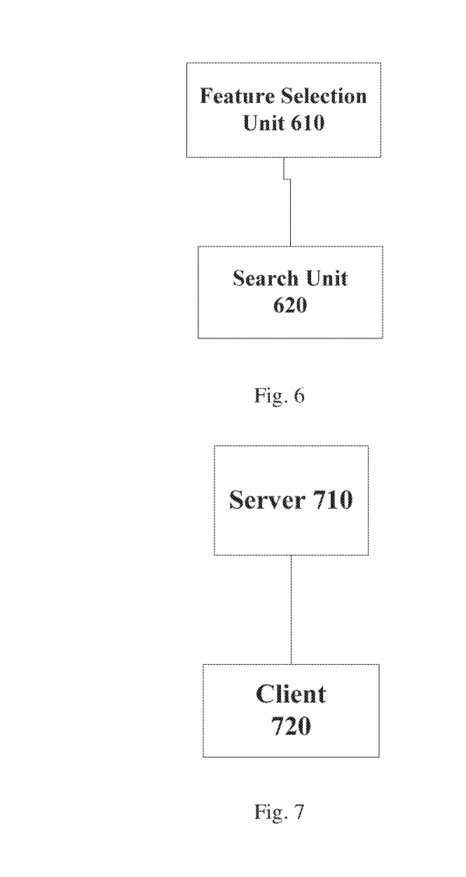

In the embodiment, a device for quick searching a video segment is provided. The device is operated at a client, including a feature selection unit 610 and a search unit 620, as shown in FIG. 6.

The feature selection unit 610 is configured to select the first video feature. For example, the client will acquire a list of characters appeared in the entire video from the server, wherein the list may be intuitively presented on an interactive interface (for example, a TV screen) of the client. At this moment, the user may use the feature selection unit 610 to optionally click a respective first video segment, a second video segment, a third video segment and a fourth video segment of a character 1, a character 2, a character 3 and a character 4 on the interactive interface.

The search unit 620 is configured to search a time point when the first video feature appears in the video based on the selection.

Wherein, when the first video feature appears in each frame after the staring frame in the video, the number of the first video feature is accumulated until the first video feature does not appear in an ending frame, and a video fragment with respect to the first video feature is formed between the starting frame and the ending frame. Each frame at which the first video feature appears corresponds to a time point when the first video feature appears in the video.

The embodiment is employed to search the video segment by the client, and the user can conveniently search and observe a desired video segment with respect to the specific video feature through the effective cooperation between the server and the client. Compared with the searching method regarding a fixed time point in the prior art, searching a video segment with respect to a specified video feature employed in the present disclosure is much more convenient and quicker.

Hereinafter, a seventh embodiment will be introduced.

In the embodiment, a system for quick searching a video segment is provided. The system includes a server 710 and a client 720, as shown in FIG. 7.

The server 710 is configured to analyze each frame in a video, set a frame as a starting frame when a first video feature appears in the frame analyzed, and record a time point when the starting frame appears in the video; when the first video feature appears in each frame following the staring frame, accumulate the number of the first video feature until the first video feature does not appear in an ending frame, and form a video segment with respect to the first video feature between the starting frame and the ending frame, such that the time point when the first video feature appears in the video can be searched.

The client 720 is configured to select the first video feature, and search a time point when the first video feature appears in the video based on the selection, wherein when the first video feature appears in a video picture of each frame following the staring frame, the number of the first video feature is accumulated until the first video feature does not appear in an ending frame, and a video segment with respect to the first video feature is formed between the starting frame and the ending frame.

The embodiment is employed to complete selection of the video segment with respect to the specific video feature by using the server to conduct processing, and then the video segment is searched at the client. In this way, a user can conveniently search and observe a desired video segment with respect to the specific video feature through the effective cooperation between the server and the client. Compared with the searching method at a fixed time point in the prior art, searching a video segment with respect to a specified video feature employed in the present disclosure is much more convenient and quicker.

Hereinafter, an eighth embodiment will be introduced.

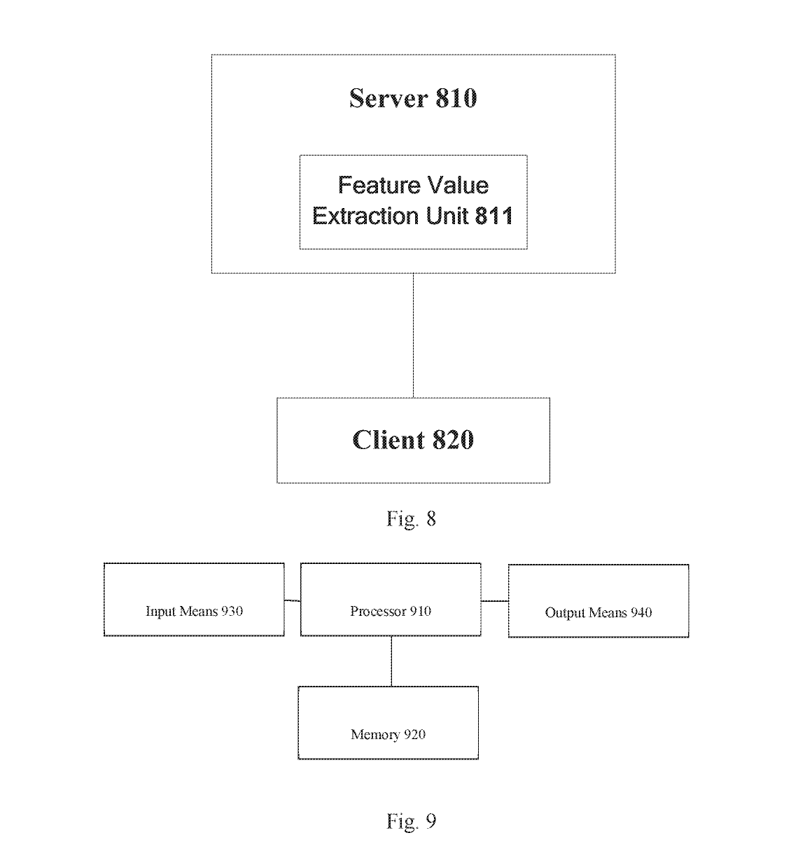

In the embodiment, a system for quick searching a video segment is provided. The system includes a server 810 and a client 820, as shown in FIG. 8.

The server 810 is configured to analyze each frame in a video, set a frame as a starting frame when a first video feature appears in the frame analyzed, and record a time point when the starting frame appears in the video; when the first video feature appears in each frame following the staring frame, accumulate the number of the first video feature until the first video feature does not appear in an ending frame, and form a video fragment with respect to the first video feature between the starting frame and the ending frame, such that the time point when the first video feature appears in the video can be searched.

The server 810 further includes a feature value extraction unit 811, the feature value extraction unit being configured to extract a feature value with respect to the first video feature at the starting frame according to an algorithms library, and store the feature value.

The client 820 is configured to select the first video feature, and search a time point when the first video feature appears in the video based on the selection, wherein when the first video feature appears in a video picture of each frame following the staring frame, the number of the first video feature is accumulated until the first video feature does not appear in an ending frame, and a video segment with respect to the first video feature is formed between the starting frame and the ending frame.

The embodiment is employed to search the video segment by the client, and the user can conveniently search and observe a desired video segment with respect to the specific video feature through the effective cooperation between the server and the client. Moreover, because the feature value of the video feature is stored in the remote server, the feature value can be stored, such that other parties may acquire the feature value, and use the feature value to search a specified video feature. Compared with the searching method at a fixed time point in the prior art, searching a video segment with respect to a specified video feature employed in the present disclosure is much more convenient and quick.

In brief, according to the embodiments of the present disclosure, the video segment with respect to the specific video feature (for example, a character) is processed through the server, then the video segment is searched at the client. In this way, a user can conveniently search and observe a desired video segment with respect to the specific video feature through the effective cooperation between the server and the client. Compared with the searching method regarding a fixed time point in the prior art, searching a video segment with respect to a specified video feature employed in the embodiments of the present disclosure is much more convenient and quicker.

Those skilled in the art will appreciate that all or some of the steps in the method for implementing the foregoing embodiments may be a relevant hardware instructed by a computer program, and such a computer program may be stored in a computer-readable storage medium. The program in execution may include the steps of the embodiments of above methods, wherein, the storage medium may be a magnetic disk, an optical disk, a read-only memory (Read-Only Memory, ROM), or a random access memory (Random Access Memory, RAM), etc.

Based on such understanding, the technical solution of the embodiments of the present disclosure essentially, or the part contributing to the prior art, or the part of the technical solution may be implemented in the form of a software product. The computer software product is stored in a storage medium, and includes several instructions for instructing a mobile terminal (which may be a personal computer, a server, or a network device so on) to execute the all or a part of steps of the method according to each embodiment of the present disclosure. While the above-mentioned storage medium includes: any medium that is capable of storing program codes, such as a USB disk, a mobile hard disk drive, a read-only memory (ROM, Read-Only Memory), a random access memory (RAM, Random Access Memory), a magnetic disk, or an optical disk.

The device embodiments described above are only exemplary, wherein the units illustrated as separation parts may either be or not physically separated, and the parts displayed by units may either be or not physical units, i.e., the parts may either be located in the same plate, or be distributed on a plurality of network units. A part or all of the modules may be selected according to an actual requirement to achieve the objectives of the solutions in the embodiments of the present disclosure. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer device (which may be a personal computer, a server, or a network device so on) to execute the method according to each embodiment or some parts of the embodiments.

A ninth embodiment of the present disclosure provides a nonvolatile computer-readable storage medium which stores executable instructions, wherein the above methods for quickly searching video segments according to any one embodiment as above can be performed by the executable instructions.

FIG. 9 is a hardware structure diagram of an electronic device for performing the method for quickly searching video segments according to an eleventh embodiment of the present disclosure.

As shown in FIG. 9, the electronic device includes one or more processors 910 and a memory 920. FIG. 9 takes one processor 910 as an example.

The electronic device for performing the method for quickly searching video segments may further include an input means 930 and an output means 940.

The processor 910, the memory 920, the input means 930 and the output means 940 may be connected via a bus or in other ways. In FIG. 9, these elements are connected via a bus.

The memory 920 can be used as a nonvolatile computer-readable storage medium, which can store a nonvolatile software program, a nonvolatile computer-executable program, and respective modules. For example, the medium stores program instructions/modules for performing the method for quickly searching video segments according to the embodiments of the present disclosure, such as the video feature analysis unit 510, the video feature extraction unit 511, and the video segment generation unit 520. The processor 910 executes the nonvolatile software program, instructions and/or modules stored within the memory 920, so as to perform several functional applications and data processing, particularly, perform the method for quickly searching video segments according to the above embodiments as above.

The memory 920 may include a storage program zone and a storage data zone. The storage program zone may store an operating system and at least one application program for achieving respective functions. The storage data zone may store data created according to the usage of the icon sequencing device. In addition, the memory 920 may further include a high speed random access memory and a nonvolatile memory, e.g. at least one of a disk storage device, a flash memory or other nonvolatile solid storage device. In some embodiments, the memory 920 may include a remote memory remotely located relative to the processor 910, and this remote memory may be connected, via a network, to the icon sequencing device for an intelligent television desktop. For example, the network includes but is not limited within internet, intranet, local area network, mobile communication network and any combination thereof.

The input means 930 can receive an input user-clicking, and generate a signal input associated with a user setting and a functional controlling of the icon sequencing device. The output means 940 may include a display device such as a displaying screen, for displaying results of icon-sequencing and related information.

One or more storage modules are stored within the memory 920. When the one or more storage modules are operated by one or more processors 910, the method for quickly searching video segments of the above embodiments is performed.

The products as above-mentioned may perform methods provided by the embodiments of the present disclosure, have functional modules for performing the methods, and achieve respective beneficial effects. For those technical details which are not mentioned in this embodiment, please refer to the methods provided by the embodiments of the disclosure. The electronic device of the embodiment of the present disclosure may be constructed in several forms, which include but are not limited within:

(1) mobile communication device: this type of terminal has a function of mobile communication for main propose of providing a voice/data communication. This type of terminal includes: a smartphone (e.g. iPhone), a multimedia mobile phone, a feature phone, a low-end cellphone and so on;

(2) ultra mobile personal computer device: this type of terminal belongs to a personal computer which has a computing function and a processing function. In general, this type of terminal has a networking characteristic. This type of terminal includes: PDA, MID, UMPC and the like, e.g. iPad;

(3) portable entertainment device: this type of device can display and play multimedia contents. This type of device includes an audio/video player (e.g. iPod), a handheld game console, an electronic book, an intelligent toy, and a portable vehicle navigation device;

(4) server: the server provides a computing service. The construction of a server includes a processor, a hard disk, an internal memory, a system bus and so on, which is similar to the construction of a general computer but can provide more reliable service. Therefore, with respect to processing ability, stability, reliability, security, extendibility and manageability, a server has to meet a higher requirement; and

(5) other electronic devices having data interchanging functions.

It should be finally noted that the above embodiments are only configured to explain the technical solutions of the embodiments of the present application, but are not intended to limit the present application. Although the embodiments of the present disclosure has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the claims.

What is claimed is:

1. An electronic device for quickly searching video segments, comprising:
at least one processor; and
a memory communicably connected with the at least one processor for storing instructions executable by the at least one processor, wherein execution of the instructions by the at least one processor causes the at least one processor to:
analyze each frame in a video one by one, set a frame as a starting frame once a specified first video feature appears in the frame, and record a time point when the starting frame appears in the video; and
when the first video feature appears in each frame following the staring frame, accumulate the number of the first video feature until the first video feature does not appear in an ending frame, and form a video segment with respect to the first video feature between the starting frame and the ending frame, such that the time point when the first video feature appears in the video can be searched.

2. The electronic device according to claim 1, wherein the processor is further configured to extract a feature value with respect to the first video feature at the starting frame according to an algorithms library and store the feature value.

3. The electronic device according to claim 1, wherein the processor is further configured to:
make a selection for the first video feature; and
search a time point when the first video feature appears in the video based on the selection, wherein when the first video feature appears in a video picture of each frame following the staring frame, the number of the first video feature is accumulated until the first video feature does not appear in an ending frame, and a video segment with respect to the first video feature is formed between the starting frame and the ending frame.

4. A method for quickly searching video segments by an electronic device, comprising:
analyzing each frame in a video, setting a frame as a starting frame once a first video feature appears in the frame analyzed, and recording a time point when the starting frame appears in the video; and
when the first video feature appears in each frame following the staring frame, accumulating the number of the first video feature until the first video feature does not appear in an ending frame, and forming a video fragment with respect to the first video feature between the starting frame and the ending frame, such that the time point when the first video feature appears in the video can be searched.

5. The method according to claim 4, wherein when a specified second video feature appears in a second frame next following the starting frame, the number of the second video feature is accumulated from the second frame until the second video feature does not appear in a specified frame, such that a video segment with respect to the second video feature is formed between the second frame and the specified frame.

6. The method according to claim 4, further comprising: extracting a feature value with respect to the first video feature at the starting frame according to an algorithms library, and storing the feature value.

7. The method according to claim 4, further comprising:
making a selection for the first video feature; and
searching a time point when the first video feature appears in the video based on the selection, wherein when the first video feature appears in a video picture of each frame following the staring frame, the number of the first video feature is accumulated until the first video feature does not appear in an ending frame, and a video segment with respect to the first video feature is formed between the starting frame and the ending frame.

8. A non-transitory computer-readable storage medium storing executable instructions that, when executed by an electronic device with a touch-sensitive display, cause the electronic device to:
analyze each frame in a video, set a frame as a starting frame once a first video feature appears in the frame analyzed, and record a time point when the starting frame appears in the video; and
when the first video feature appears in each frame following the staring frame, accumulate the number of the first video feature until the first video feature does not appear in an ending frame, and form a video fragment with respect to the first video feature between the starting frame and the ending frame, such that the time point when the first video feature appears in the video can be searched.

9. The non-transitory computer-readable storage medium according to claim 8, wherein when a specified second video feature appears in a second frame next following the starting frame, the number of the second video feature is accumulated from the second frame until the second video feature does not appear in a specified frame, such that a video segment with respect to the second video feature is formed between the second frame and the specified frame.

10. The non-transitory computer-readable storage medium according to claim 8, the electronic device is further configured to extract a feature value with respect to the first video feature at the starting frame according to an algorithms library, and store the feature value.
